(19) United States
(12) Patent Application Publication
(10) Pub. No.: US 2004/0160438 A1
(43) Pub. Date: Aug. 19, 2004

(54) A SECURITY RATINGS SYSTEM

(76) Inventors: Ching-Chih Shih, Tao Yuan Shien (TW); Shin-Yun Lin, Taipei (TW); Pi-Cheng Chen, Hsin Chuang City (TW); Wen-Yuan Hung, Hsintien City (TW)

Correspondence Address: RABIN & BERDO, P.C., Suite 500, 1101 14 Street, N.W., Washington, DC, 20005, US

(21) Appl. No.: 10/448,295

(22) Filed: May 30, 2003

(30) Foreign Application Priority Data
Jan. 30, 2003 (TW) 92102342

(51) Int. Cl. G06T 1/00; G09G 5/00; G06F 17/00; H04N 7/173; H04N 7/01; H04N 11/20; H04N 7/16; H04H 9/00

(52) U.S. Cl. 345/418; 345/603; 345/501; 345/204; 345/605; 348/441; 725/17

(57) ABSTRACT

A transformation device for remote monitoring a computer display image is described. The transformation device monitors display images of a server on a remote computer display via a network. The transformation device includes an image capture unit and a system-on-chip. The image capture unit captures the display images from the a display cable and transforms the display images into digital image data fulfilling browser safe palette requirements and corresponding synchronization signals to reduce the bandwidth requirements. The system-on-chip transforms the digital image data and the corresponding synchronization signals into network packets and delivers the network packets to the remote computer so as to display instantly the display images of the server on a display of the remote computer.

### FIELD OF THE INVENTION

The present invention relates to the remote utilization of a transformation device to monitor display images of a server computer via networks, and especially relates to remote utilization of a transformation device to monitor display images on a server computer without running a working operating system (OS).

### BACKGROUND OF THE INVENTION

Computers have been widely applied in all fields and network technologies have rapidly progressed. Therefore, people can easily access information and provide service by way of networks. Hence, the growing network provides people with a comfortable and fast information environment.

At this time, there is a lot of information to be distributed over the network. Therefore, a network established with only few computers provides insufficient service. Network systems are established with more computers and the computer apparatuses may even be distributed over different places throughout the world. Computer apparatuses, such as workstations, servers, database memory, routers, and backup devices, connect with each other via the network so as to provide diverse services.

At this stage, people controlling the server computer via the network have to install a remote control software based on a working operating system (OS). For this management method, an OS, such as the Windows operating system supporting the network, must already be installed in the computer. That is to say, the conventional remote computers can control the server computers via the network only if the server computers and the remote computers both use the OS supporting the network and the remote control software.

However, if a server computer is just turned on and the operating system is not ready, for example the operating system is at the BIOS setting stage or is still in a starting procedure stage, a remote computer has no opportunity to access the server computer so that the remote computer cannot monitor and manage the server computer. Accordingly, there is a control breach for remotely controlling server computers via the network.

### SUMMARY OF THE INVENTION

One object of the present invention is to provide a transformation device that remotely monitors display images of a server computer via networks and reproduces the images on a remote computer display. The server computer can be monitored by the remote computer even when the operating system of the server computer is not ready, and therefore the remote control function can be improved. Hence, from turning on the server computer, BIOS setting, and even reinstalling the operating system, that is to say, from normal working conditions to system crash, the display image of the server computer can be always monitored by the remote computer.

Another object of the present invention is to provide a transformation device for remote monitoring of computer display images to reduce image data communication quantity in a network so as to improve the image transmitting efficiency in the network.

The present invention provides a transformation device for remotely monitoring a computer display image. The transformation device connects to a server computer and a remote computer via a network to monitor a display image on the server computer display via network. The transformation device includes an image capture unit and a system-on-chip.

The image capture unit connects to a video signal output port of the server computer by a cable to get display image information on the server computer from the video signal output port and transforms the display image information into digital browser image data fulfilling a color requirement of a browser and corresponding synchronization signals. The system-on-chip connects to the image capture unit and the network and receives the digital browser image data and the corresponding synchronization signals, compresses the same into network packets, and then transmits the network packets to the remote computer via the network. Therefore, the remote computer can instantly display the display image of the server computer.

The image capture unit further comprises an analog-to-digital converter and a programmable integrated circuit. The analog-to-digital converter transforms the display image information of the server computer into digital image data and corresponding synchronization signals, and transmits the digital image data and corresponding synchronization signals to the programmable integrated circuit. The programmable integrated circuit transforms the digital image data into digital browser image data that fulfill requirements of a browser software utilized in the remote computer. For example, the digital browser image data fulfills a browser-safe palette that utilizes 216 colors to represent each pixel.

The corresponding synchronization signals comprise vertical synchronization (VSYNC) signals and horizontal synchronization (HSYNC) signals. The analog-to-digital converter outputs the digital image data with red, green, and blue (RGB) digital image data and each of the RGB digital image data is 8 bits of digital image data. The programmable integrated circuit only accepts three dominant color bits of the 8 bits of digital image data, that is to say, the more influential three bits. The programmable integrated circuit therefore transfers the dominant color data to the digital browser image data that fulfill the browser-safe palette with 216 colors for representing each pixel and the network bandwidth and digital data processing time can be reduced.

Hence, with the transformation device for remote monitoring of a computer display image according to the present invention, a remote computer can instantly monitor the displaying image of the server computer display. The server computer supervisor can ascertain the situation of the server computer without any operating system supporting network through the network.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic network architecture of a preferred embodiment with a transformation device for remote monitoring of a computer display image according to the present invention; and

FIG. 2 is a block diagram of a transformation device for remote monitoring a computer display image according to the present invention.

### DETAILED DESCRIPTION OF THE PREFERRED EMBODIMENT

The following description is the best presently contemplated mode of carrying out the present invention. This description is not to be taken in a limiting sense but is made merely for the purpose of describing the general principles of the invention. The scope of the invention should be determined by referencing the appended claims.

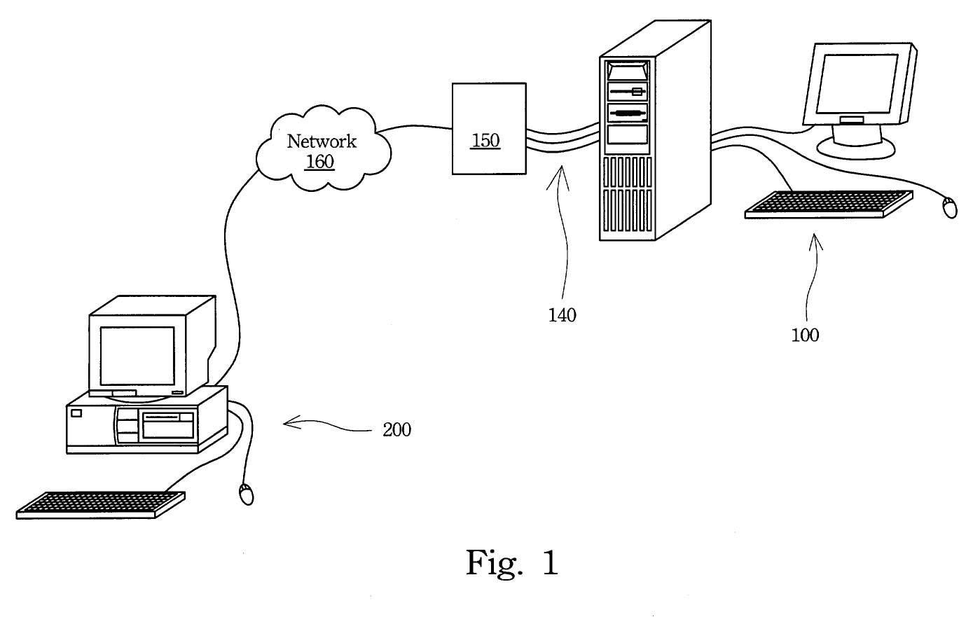

FIG. 1 is a schematic network architecture of a preferred embodiment with a transformation device for remote monitoring a computer display image according to the present invention. By way of a transformation device for remote monitoring a computer display image 150 according to the present invention, a remote computer 200 display can instantly monitor display images of the server computer 100 via a network 160. A connecting cable 140 connects the transformation device 150 to the server computer 100. The connecting cable 140 is a standard cable for transmitting server computer image data to a local display, for example a display cable, a USB cable, or any signal transmission cable that can transmit image data.

With the transformation device 150 for remote monitoring a computer display image according to the present invention, the display module of the remote computer 200 can monitor the server computer 100. Furthermore, with the transformation device 150, the remote computer 200 can monitor the server computer 100 in any kind of situation, such as an operating system of the server computer 100 ready or not ready, restarting the server computer 100, or setting BIOS. The remote computer 200 can monitor the server computer 100 with the transformation device 150 according to the present invention through the network 160 whenever needed.

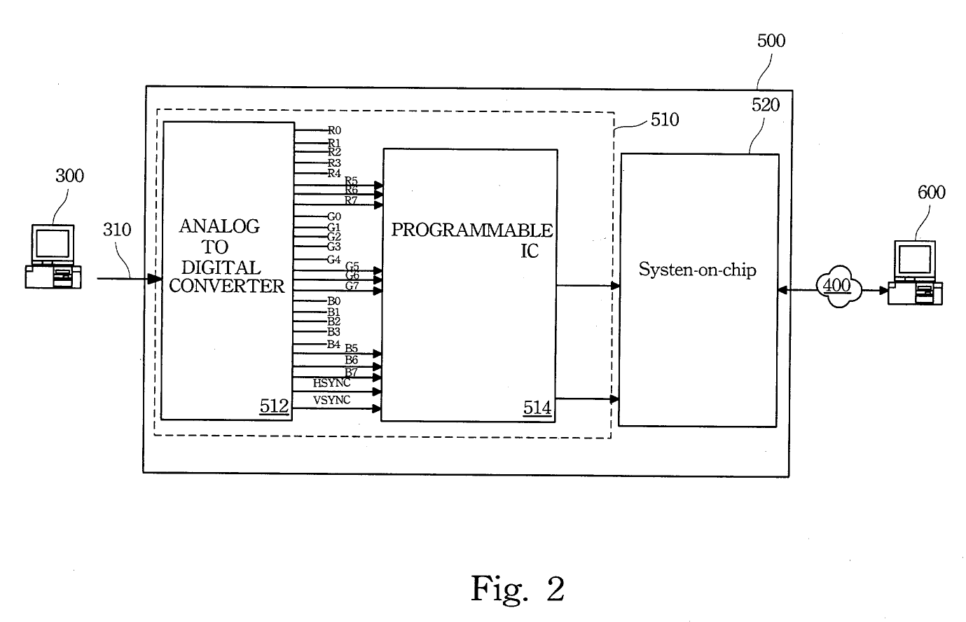

FIG. 2 is a block diagram of a transformation device for remote monitoring a computer display image according to the present invention. The function and work process are illustrated with the following description and FIG. 2. The transformation device 500 for remote monitoring a computer display image according to the present invention connects to a server computer 300 by a display cable 310. The transformation device 500 further connects to a remote computer 600 by a network 400 for remote monitoring of the server computer 300.

The transformation device 500 includes an image capture unit 510 and system-on-chip 520. One end of the image capture unit 510 connects to the display cable 310 and another end thereof connects to the system-on-chip 520. The image capture unit 510 includes an analog-to-digital converter (A/D converter) 512 and a programmable integrated circuit (IC) 514. The system-on-chip 520 connects to the remote computer 600 via network 400.

The following description will illustrate functions and working processes of the foregoing disclosed preferred embodiment to allow a person skilled in the art to realize the spirit of the present invention rather than to limit the present invention.

When the server computer 300 is turned on, the transformation device 500 receives the image signals on the display of the server computer 300 directly from the display cable 310. Firstly, these image signals are transmitted to the image capture unit 510 and are transformed into digital image signals, corresponding vertical synchronization (VSYNC) signals and horizontal synchronization (HSYNC) signals from the A/D converter 512 of the image capture unit 510. A/D converter 512 then transmits these signals to the programmable IC 514. For reducing the network transmission bandwidth and data processing time, the present invention reduces these signals in size when these signals are transmitted to the programmable IC 514. For example, referring to the drawing, each color R, G, and B includes 8 bits to represent the color in the digital signals. The present invention cancels the lower 5 bits of data, such as R0, R1, R2, R3, R4, G0, G1, G2, G3, G4, B0, B1, B2, B3, and B4. Therefore, digital signals R5, R6, R7, G5, G6, G7, B5, B6, and B7 remain; that is to say, the present invention keeps these more influence bits to display each pixel. Therefore, the transformation device according to the present invention can effectively reduce the bandwidth requirement for transmitting these digital signals and the data processing time but only influence the color accuracy lightly. The present invention is not only limited to receive analog signals from the server computer 300 but also directly receives digital signals from the server computer 300. The programmable IC 514 collects the dominant color bits, such as bit 6-bit 8 for each color R, G and B, cancels the subordinate color bits, such as bit 0-bit 5 for each color R, G and B, transforms the dominant color bits to requirement digital image signals, and then transmits the same to the system-on-chip 520.

The programmable IC 514 of the transformation device according to the present invention further transforms the digital data of the dominant color bits into digital data fulfilling browser requirements, for example a browser-safe palette with each color including 7 grades, 0-6. Therefore, 8 bits are needed to represent all colors, 216 colors, of the browser-safe palette. Hence, the transformation device for remote monitoring a computer display image can effectively reduce the data transmission quantity via the network, thereby reducing bandwidth requirement, and furthermore the display image of the server computer 300 can be instantly monitored on the display of the remote computer 600. In the meantime, the system-on-chip 520 compresses the digital image signal together with the HSYNC signals and VSYNC signals into the network packets and transmits the same to the remote computer 600 via the network 400. Accordingly, in the meantime, the display image of the server computer 300 is reproduced on the display of the remote computer 600.

When a server computer supervisor wants to manage the server computer with a remote computer, the first step is to get the display image on the server computer to understand the condition of the server computer. The remote computer needs to utilize either a predetermined application program installed in the remote computer or a browser program supporting Java applets to control the server computer. If the remote computer uses the predetermined application program, the remote computer has to install the predetermined application program before controlling the server computer. If the remote computer uses a browser with Java applet support, the remote computer only needs to connect with the transformation device for remote monitoring a computer display image according to the present invention via the network, and the remote computer can directly download the management applet from the transformation device and immediately remotely display the display image of the server computer on the remote computer.

Either using the predetermined application program installed in the remote computer or using the management applet downloaded from the transformation device, the remote computer can instantly directly receive and display the compressed network packets, with the data of the display image in the server computer, according to the network communication protocol while the remote computer accesses the transformation device.

The remote computer receives the network packets of display images of the server computer and immediately reproduces these images on the display of the remote computer. Therefore, the server computer supervisor is able to ascertain the working situation of the server computer. By way of the transformation device for remote monitoring a computer display image according to the present invention, the remote computers can instantly demonstrate the display images of the server computer via the network, and therefore any server computer with the transformation device according to the present invention can transmit the display images thereon to a remote computer while the server computer is in any working condition. Even if the server computer is conducting a reboot procedure, reinstalling operating procedures, setting BIOS, or any traditional procedure lacking a network support function, the remote computer can directly control and monitor the server computer with the transformation device according to the present invention.

Hence, with the transformation device for remote monitoring computer a display image according to the present invention, even if the server computer lacks a working operating system, the remote computer still can get the display image from the transformation device according to the present invention. Therefore, the server computer can be fully in control at any time and especially when the server computer is in an error procedure. The transformation device according to the present invention can immediately send the images of the error message on the server computer display to the remote computer display. The supervisor can determine how to resolve the error according to the error message provided by the transformation device according to the present invention. The present invention provides a transformation device to show the server computer working status without any control breach, and therefore effectively improves the traditional network server management.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A transformation device for remote monitoring a computer display image, the transformation device connecting to a server computer and a remote computer via a network, the transformation device comprising:
an analog-to-digital converter connecting to a video signal output port of the server computer by a cable to get a display image information on the server computer from the video signal output port and transform the display image information into a digital image data and a plurality of corresponding synchronization signals;
a programmable integrated circuit connecting to the analog-to-digital converter to receive the digital image data and the corresponding synchronization signals and transform the digital image data into a digital browser image data fulfilling a color requirement of a browser on the remote computer; and
a system-on-chip connecting to the programmable integrated circuit and the network, the system-on-chip compressing the digital browser image data and the corresponding synchronization signals into network packets and transmitting the network packets to the remote computer via the network.

2. The transformation device of claim 1, wherein the transformation device comprises a display cable.

3. The transformation device of claim 1, wherein the corresponding synchronization signals comprise vertical synchronization (VSYNC) signals and horizontal synchronization (HSYNC) signals.

4. The transformation device of claim 1, wherein the digital image data comprise red, green, and blue (RGB) digital image data.

5. The transformation device of claim 1, wherein each RGB digital image data unit comprises 8 bits of digital image data.

6. The transformation device of claim 1, wherein the programmable integrated circuit only accepts three dominant color bits of the 8 bits of digital image data for transformation into digital browser image data.

7. The transformation device of claim 1, wherein the digital browser image data comprise 216 colors for each pixel, fulfilling a browser-safe palette requirement.

8. A remote monitoring computer display image transformation system, comprising:
a server computer;
a remote computer;
a network connecting the server computer and the remote computer to transmit network packets between the server computer and the remote computer; and
a remote monitoring computer display image transformation device connected between the server computer and the network, wherein the remote monitoring computer display image transformation device further comprises:
an analog-to-digital converter connecting to a video signal output port of the server computer by a cable to get a display image information on the server computer from the video signal output port and transform the display image information into a digital image data and a plurality of corresponding synchronization signals;
a programmable integrated circuit connecting to the analog-to-digital converter to receive the digital image data and the corresponding synchronization signals and transform the digital image data into a digital browser image data fulfilling a color requirement of a browser on the remote computer; and
a system-on-chip connecting to the programmable integrated circuit and the network, the system-on-chip compressing the digital browser image data and the corresponding synchronization signals into network packets and transmitting the network packets to the remote computer via the network.

9. The remote monitoring computer display image transformation system of claim 8, wherein the remote monitoring computer display image transformation system comprises a display cable.

10. The remote monitoring computer display image transformation system of claim 8, wherein the corresponding synchronization signals comprise vertical synchronization (VSYNC) signals and horizontal synchronization (HSYNC) signals.

11. The remote monitoring computer display image transformation system of claim 8, wherein the digital image data comprises red, green, and blue (RGB) digital image data.

12. The remote monitoring computer display image transformation system of claim 11, wherein each of the RGB digital image data comprises 8 bits of digital image data.

13. The remote monitoring computer display image transformation system of claim 12, wherein the programmable integrated circuit only accepts three dominant color bits of the 8 bits of digital image data to transform into digital browser image data.

14. The remote monitoring computer display image transformation system of claim 8, wherein the digital browser image data comprise 216 colors for each pixel fulfilling a browser-safe palette requirement.

15. The remote monitoring computer display image transformation system of claim 8, wherein the remote computer utilizes a browser software to control the server computer.

16. A transformation device for remote monitoring a computer display image, the transformation device connecting to a server computer and a remote computer via a network, the transformation device comprising:
an image capture unit connecting to a video signal output port of the server computer by a cable to get a display image information on the server computer from the video signal output port and transform the display image information into a digital browser image data fulfilling a color requirement of a browser and a plurality of corresponding synchronization signals; and
a system-on-chip connecting to the image capture unit and the network, the system-on-chip compressing the digital browser image data and the corresponding synchronization signals into network packets and transmitting the network packets to the remote computer via the network.

17. The transformation device of claim 16, wherein the image capture unit further comprises:
an analog-to-digital converter transforming the display image information of the server computer into a digital image data and a plurality of corresponding synchronization signals; and
a programmable integrated circuit connecting to the analog-to-digital converter to receive the digital image data and the corresponding synchronization signals and transfer the digital image data to the digital browser image data.

18. The transformation device of claim 16, wherein the corresponding synchronization signals comprise vertical synchronization (VSYNC) signals and horizontal synchronization (HSYNC) signals.

19. The transformation device of claim 16, wherein the digital image data comprise red, green, and blue (RGB) digital image data and each of the RGB digital image data is 8 bits of digital image data.

20. The transformation device of claim 19, wherein the programmable integrated circuit only accepts three dominant color bits of the 8 bits of digital image data to transfer to the digital browser image data.
